(19) United States
(12) Patent Application Publication
(10) Pub. No.: US 2002/0100723 A1
(43) Pub. Date: Aug. 1, 2002

(54) Water filtration system

(76) Inventor: John Courtney, St. Albans.Hertfordshire (GB)

Correspondence Address: Thomas M. Galgano, Esq., GALGANO & BURKE, Suite 135, 300 Rabro Drive, Hauppauge, NY, 11788, US

(21) Appl. No.: 09/772,369

(22) Filed: Jan. 30, 2001

(51) Int. Cl. B01D 35/02

(52) U.S. Cl. 210/446; 210/450; 210/455

(57) ABSTRACT

A water filter apparatus to filter piped water which is adapted to be coupled to piping of a piped water system, and which includes an elongated tubular housing body in which a solid filter element mounts, in use, extending along the housing, the tubular housing body having a first open end by means of which the filter element may be inserted into or removed from within the tubular housing body, a housing end cap which mounts over the first open end of the housing body and which has an aperture therethrough to, in use, be placed in fluid communication with the interior of a length of piping of the piped water system, and a replaceable filter cartridge including the filter element securely fastened to a supportive end body, to support the filter element within the housing body, the supportive end body having the form of a cap which is fastened over one end of the filter element and which, in use, channels fluid through the filter element to or from the aperture of the housing end cap.

### FIELD OF THE INVENTION

The present invention concerns improvements in and relating to water filtration systems and is particularly, although not necessarily exclusively, relevant to water filtration systems for providing filtered drinking water from mains tap water/piped water.

### BACKGROUND TO THE INVENTION

Nowadays it is widely appreciated that the consumption of adequate quantities of water on a daily basis is very important to general health and vitality. For the average male the recommended daily allowance is of the order of 1.5 liters of water. For many the daily intake of water is through drinking hot beverages such as tea and coffee, as well as fruit juices. However, it is now widely held that the best source of dietary water is pure filtered water—since tea and coffee both naturally contain caffeine which is a diuretic and will actually lead to increased loss of water from the body in urine, and thereby undermine the body's water balance. Fruit juices are not as beneficial as pure water, in view of their high sugar content which undermines absorption and optimal use of the water from the juice.

In view of these factors, it is highly important to provide a readily available source of substantially pure water free of harmful and distasteful contaminants to be consumed in working or domestic environments. For the consumer the filtration apparatus should be economical to install and run, compact, and ready to use with minimal intervention and need for maintenance. This is suitably achieved by providing a filtration apparatus that can be fitted to a mains tapwater system, suitably in the consumer's premises to filter out some or all of the impurities that the mains water suppliers did not remove, or which entered the water from the distribution pipework. These impurities may be small particles or may even be molecules that adversely affect the taste and odour of the water.

A wealth of designs of water filtration systems have developed to meet this need, but none are optimally compact, economic and efficient. One particular design that has proven popular makes use of a housing that couples “in-line” to a mains water supply system and which accommodates an actuated carbon filter medium in granular form. Such existing filters are relatively bulky and are not optimally cost effective to maintain.

It is a general objective of the present invention to provide an improved water filter system for filtering piped water to remove impurities in the piped water and which addresses some or all of the problems of the aforementioned prior art.

### SUMMARY OF THE INVENTION

According to a first aspect of the present invention there is provided:

an improved water filter apparatus to filter piped water which is adapted to be coupled to piping of a piped water system, and which comprises:

an elongate tubular housing body in which a solid filter element mounts, in use, extending along the housing, the tubular housing body having a first open end by means of which the filter element may be inserted into or removed from within the tubular housing body;

a housing end cap which mounts over said first open end of the housing body and which has an aperture therethrough to, in use, be placed in fluid communication with the interior of a length of piping of a said piped water system; and

a replaceable filter cartridge comprising a said filter element securely fastened to a supportive end body, to support the filter element within the housing body, the supportive end body having the form of a cap which is fastened over one end of the filter element and which, in use, channels fluid through the filter element to or from the aperture of the housing end cap.

Preferably the supportive end body is adapted to be held by fastening of the housing end cap to the housing body to thereby mount and position the filter element in the housing body.

Suitably the supportive end body has one or more projections that are adapted to be sandwiched between a face of the housing end cap and a face of the housing body to hold the supportive end body in place when the housing end cap is fastened onto the housing body.

The supportive end body is suitably circular and has an annular flange or other projection radiating therefrom, to be trapped between said face of the housing end cap and said first end of the housing body.

The supportive end body is preferably a supportive end spigot, having a tubular spigot projection which, in use, extends outwardly through the aperture in the housing end cap and which may be coupled to the piping of a piped water system.

The housing body suitably has at its end distal to its first end an integrally assembled or integrally formed spigot portion for coupling to piping of a said piped water system.

Advantageously there is provided a sealing means between the supportive end body and the housing body to provide a water tight seal between the supportive body and the housing body. Suitably the sealing member is an O-ring seal which seats within a groove provided in the first end of the tubular housing body.

The housing end cap is preferably internally screw threaded to co-operatively engage with external screw threading on the housing body.

The filter cartridge suitably further has a filter end cap which is fixed over the distal end of the filter element remote from the supportive end body to direct water flowing axially through the filter element from the first end of the housing body to flow radially outwardly, or where flow is the opposite way through the system, to direct water to flow radially inwardly.

The filter cartridge suitably has a filter end cap which is fixed over the distal end of the filter element remote from the supportive end body and having radiating lugs to help to centralise the filter element in the housing body.

According to a second aspect of the present invention there is provided a replaceable filter cartridge for an improved water filter apparatus of the first aspect of the invention and which comprises: a solid filter element securely fastened to a supportive end body to support the filter element within the housing body of a said water filter apparatus and having the form of a cap which is fastened over one end of the filter element and which, in use, channels fluid through the filter element to or from a said aperture of a said housing end cap of a said water filter apparatus.

### BRIEF DESCRIPTION OF THE DRAWINGS

A preferred embodiment of the present invention will now be more particularly described, by way of example, with reference to the accompanying drawings, wherein:

FIGS. 1A, 1B and 1C are, respectively, a longitudinal sectional view, an end elevation view and an isometric view of a tubular housing body of the water filter;

FIGS. 2A, 2B and 2C are, respectively, a longitudinal sectional view, an end elevation view from one side and an end elevation view from the other side of a filter housing end cap;

FIGS. 3A, 3B and 3C are, respectively, a longitudinal sectional view, an elevation view and isometric view of a filter-supportive end spigot;

FIGS. 4A, 48 and 4C are, respectively, a sectional view, an isometric view from one end and an isometric view from the other end of a filter element centralising end cap; and

FIG. 5 is a longitudinal sectional view of the water filter apparatus assembled for use.

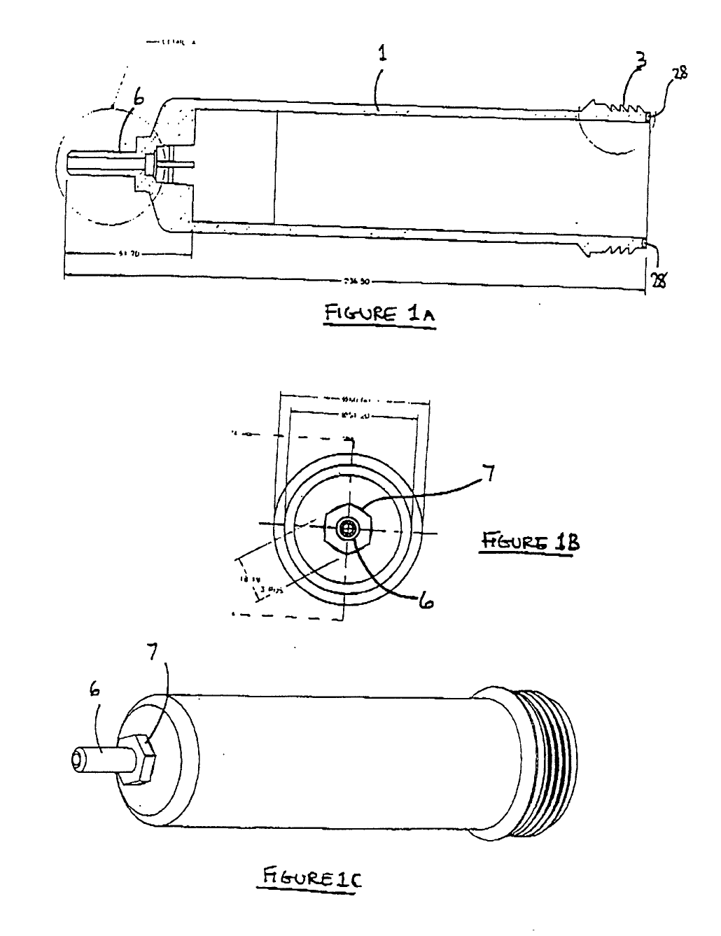

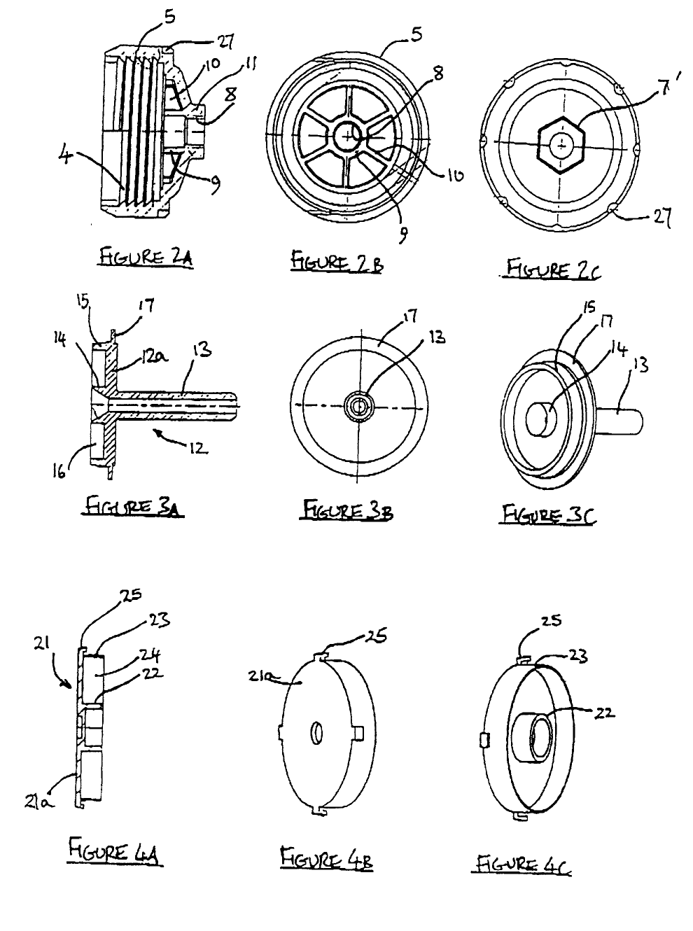

### DESCRIPTION OF THE PREFERRED EMBODIMENT

Referring to the figures, the preferred embodiment of water filter apparatus comprises a substantially circular cylindrical tubular housing body 1, suitably formed of a thermoplastics material and which is of substantially uniform inside and outside diameter for much of its length. The housing body 1 houses a solid circular cylindrical filter element 2 which may, for example, be a block of compressed granular activated carbon, extending therealong in use (see FIG. 5). It has a broad open bore at one end for insertion or removal of the filter element 2 and which is screw threaded 3 on its outside diameter to threadingly engage with corresponding internal screw threads 4, of a filter housing end cap 5.

At the alternate end of the housing body 1, the body 1 tapers in three insteps to a terminal portion 6 of relatively narrow inside and outside diameter, being generally in the form of a spigot which is integral to the housing body 1.

The integral spigot-shaped terminal portion 6 of the housing body 1 is to be coupled to the pipework of an existing water supply installation and is provided with a hexagonal shoulder portion 7 to facilitate gripping of the housing 1 with a spanner or wrench.

The filter housing end cap 5 which mounts to the broader end of the housing body 1 has a central aperture 8 which, when the housing end cap 5 is screwed in place, is substantially longitudinally aligned with the bore of the spigot 6 in the alternate end of the housing body 1. The aperture B is defined by a circular cylindrical wall 11 that projects longitudinally outwardly from the end cap 5, and by a similar circular cylindrical portion 9 which projects longitudinally inwardly of the end cap 5.

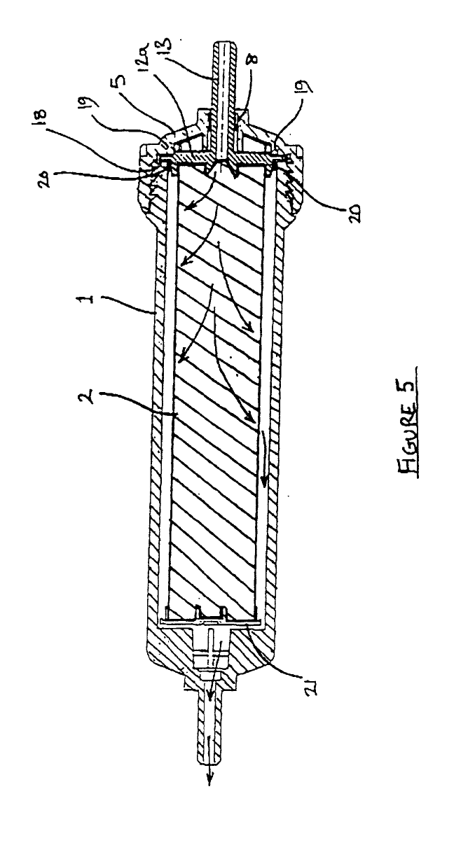

The inward projecting tubular portion 9 of the end cap 5 has an array of arms 10 radiating therefrom. The purpose of the inward projection 9 and radiating arms 10 is to provide a seat against which an end spigot 12 (see FIGS. 3 and 5) seats in use.

The end spigot 12 is, unlike the end spigot portion 6 of the housing body 1, not integral with either the housing body 1 or the cap 5. The end spigot 12 is, instead, integrally assembled to the filter element 2, being pre-fitted to one end of the filter element 2 so that when the filter element 2 is installed within the chamber of the housing body 1, the supportive end spigot 12 will centralise and support the element 2 within the housing body 1, and with a tubular spigot portion 13 of the supportive end spigot 12 projecting longitudinally outwardly through the aperture 8 in the end cap 5, so that the outermost end of the tubular spigot portion 13 of the end spigot 12 is externally exposed to be able to couple to water supply/delivery pipework.

As can be seen from FIG. 3,A-C, the end spigot 12 comprises an annular plate portion 12a which seats against the support web that is comprised by the inner cylindrical portion 9 and arms 10 of the cap 5.

Projecting longitudinally inwardly from the annular plate portion 12a of the supportive end spigot 12 are inner 14 and outer 15 annular walls which define between them an annular channel 16 into which one end of the filter element 2 is embedded. The filter element 2 is suitably secured in place to the supportive end spigot 12 by means of an adhesive or other bonding means.

Projecting circumferentially outwardly from the annular plate portion 12a of the end spigot 12 is an annular flange 17.

When the tubular housing body 1 and filter housing end cap 5 are threadedly coupled together as illustrated in FIG. 5, the annular flange 17 of the supportive end spigot 12 is sandwiched between an end face of 18 of the housing body 1 and an inner shoulder 19 of the housing end cap 5. This firmly and stabley secures the end spigot 12 in place to securely hold the filter element 2 extending longitudinally of the housing body 1.

Furthermore, an annular O-ring seal 20 is provided at this juncture between the end spigot 12 and the housing body 1 to provide a watertight seal there between. In the FIG. 5 illustration, the O-ring seal 20 is illustrated as provided between the outside diameter of the radially outer cylindrical wall 15 of the end spigot 12, and the internal wall of the housing body 1. Alternatively, and suitably, the O-ring 20 may be provided between the end face 18 of the housing body 1 and the annular flange 17 of the end spigot 12 being held in an annular groove 28 in the end face 18 of the housing body 1. The O-ring 20 will compress when the housing end cap 5 is tightened down on to the housing body 1 to give a firm watertight seal between the body 1 and supportive end spigot 12.

As can be seen from FIG. 5, this configuration of the water filter apparatus assembly comprising the housing body 1, the housing body end cap 5, supportive end spigot 12 and filter element 2 provides a pathway for water from the pipework that is mounted to the tubular spigot part 13 of the supportive end spigot 12, directly into or out of the filter element 2 (depending upon preferred direction of flow through housing body 1). In the illustrated direction of flow inwardly from the end spigot 12, the water to be purified will pass along the filter element 2 and radially outwardly into the surrounding annular chamber of the housing 1 and will then flow around the far end of the filter element 2 to eventually pass out through the spigot portion 16 at the far end of the housing body 1.

To protect the far end of the filter element 2 from damage and to provide optimum stability and centrallsation of the filter element 2 within the housing body 1, an end cap 21 is provided securely mounted to the far end of the filter element 2. In common with the supportive end spigot 12, this end cap 21 has a plate portion 21 a with upstanding inner and outer circumferential walls 22, 23, defining an annular channel 24 there between into which the filter element 2 is bedded. Unlike the end spigot 12, however, the end cap 21 is blind, not having an aperture to provide a passage through its centre. Instead, the filtered water passes around the outer circumference of the end cap 21. To assist this, as will be seen from FIGS. 4B, 4C, the end cap 21 has lugs 25 at radially spaced intervals therearound. These help to centralise the end cap 21, spacing it away from the bore of the housing body 1.

In one preferred embodiment of the invention, the end cap 21 is formed of a thermoplastic or other material that is of a different nature to the material from which the housing body 1 is formed in order to reduce any friction therebetween and improve the ease of insertion and removal of the filter cartridge comprising filter element 2 with its pre-assembled end spigot 12 and end cap 21.

The filter element 2 with pre-assembled end spigot 12 and end cap 21 functions as a removable and replaceable cartridge for ease of maintenance and which enables straightforward interchange of different types of cartridge for different filtering actions. In contrast to conventional in-line water filter apparatus, the apparatus of the present invention is very versatile and economical in use and is highly compact. There is less wastage than in conventional inline water filter systems.

### SUMMARY OF SOME IMPORTANT FEATURES OF THE APPARATUS

Replaceable cartridge comprises filter element 2 and supportive end spigot 12—environmentally friendly, simple to install and replace and reduced cost of maintenance.

Multiple cartridge options—the design gives the ability to fit cartridges of a different type and use, e.g. sediment reduction filter element, carbon block filter element, ceramic filter element, slow melt phosphate, KDF, iodinated resin and GAC (compressed granular activated carbon) filter elements. All interchangeable cartridge types are of uniform shape and size.

Inline screw-fastening housing end cap 5—gives simple assembly/reassembly whilst maintaining a small footprint.

Housing end cap 5 screw thread 4—the buttress of the thread 4 gives fast screwing and unscrewing capability with high pressure torque being applied in the direction of the forces the product would see under use, thus ensuring continuous seal.

Screw cap 5 castellations 27—designed into the housing end cap 5 are castellations 27 and wrench flats 7, which provide additional ability to apply torque to open or close the cap 5 if required.

Replaceable O-ring 20—simple design allows for standard 0-ring to be replaced at the time of filter element 2 change if required.

O-ring seal 20—seal 20 is trapped between main housing body 1 and end spigot 12 allowing all the pressure from the cap 5 to be applied in the correct direction and without any radial twisting of the seal 20 ensuring a good seal.

Colour Coding—product manufactured in different colours to allow for easy identification Df cartridge type.

Mouldings (housing body 1, housing end cap 5, supportive end spigot 12, filter end cap 21)—mouldings are suitably date stamped to allow traceability and carry material type identification for purposes of recycling.

Filter end cap 21—end cap 21 to the cartridge is self aligning and supports the cartridge within the main housing body 1 reducing possibility of damage caused by movement due to water pressure. By capping the end of the filter element the flow into and out of the filter element within the housing body 1 is predominantly radial rather than axial thereby resolving the problem of channelling that occurs in the prior art.

End spigot 12—within the end spigot 12 is a deep internal skirt 16 which aligns the cartridge and ensures the adhesive used to secure the cartridge does not overspill into the water tract 8.

The filter housing end cap 5 self aligns to the main housing body 1 ensuring that the spigot 13 aligns with the end cap 5 and that the integral sealing face 17 of the end cap 5 is properly aligned to the main body O-ring groove 28 to ensure a good seal at all times, even when fitted by unqualified persons and hence making it very suitable for the application where they may wish to change cartridges themselves.

1. An improved water filter apparatus to filter piped water which is adapted to be coupled to piping of a piped water system, and which comprises:
an elongate tubular housing body in which a solid filter element mounts, in use, extending along the housing, the tubular housing body having a first open end by means of which the filter element may be inserted into or removed from within the tubular housing body;
a housing end cap which mounts over said first open end of the housing body and which has an aperture therethrough to, in use, be placed in fluid communication with the interior of a length of piping of a said piped water system, and
a replaceable filter cartridge comprising a said filter element securely fastened to a supportive end body, to support the filter element within the housing body, the supportive end body having the form of a cap which is fastened over one end of the filter element and which, in use, channels fluid through the filter element to or from the aperture of the housing end cap.

2. An improved water filter apparatus as claimed in claim 1 wherein the supportive end body is adapted to be held by fastening of the housing end cap to the housing body to thereby mount and position the filter element in the housing body.

3. An improved water filter apparatus as claimed in claim 2, wherein the supportive end body has one or more projections that are adapted to be sandwiched between a face of the housing end cap and a face of the housing body to hold the supportive end body in place when the housing end cap is fastened onto the housing body.

4. A water filter apparatus as claimed in claim 3 wherein the supportive end body is circular and has an annular flange or other projection radiating therefrom, to be trapped between said face of the housing end cap and said first end of the housing body.

5. A water filter apparatus as claimed in claim, 1 wherein the supportive end body is a supportive end spigot, having a tubular spigot projection which, in use, extends outwardly through the aperture in the housing end cap and which may be coupled to the piping of a piped water system.

6. An improved water filter apparatus as claimed in claim 1, wherein the housing body has at its end distal to its first end an integrally assembled or integrally formed spigot portion for coupling to piping of a said piped water system.

7. An improved water filter apparatus as claimed in claim 1, wherein there is provided a sealing means between the supportive end body and the housing body to provide a water tight seal between the supportive body and the housing body.

8. An improved water filter apparatus as claimed in claim 7, wherein the sealing member is an O-ring seal which seats within a groove provided in the first end of the tubular housing body.

9. An improved water filter apparatus as claimed in claim 1, wherein the housing end cap is internally screw threaded to co-operatively engage with external screw threading on the housing body.

10. An improved water filter apparatus as claimed in claim 1, wherein the filter cartridge further has a filter end cap which is fixed over the distal end of the filter element remote from the supportive end body to direct water flowing axially through the filter element from the first end of the housing body to flow radially outwardly, or where flow is the opposite way through the system, to direct water to flow radially inwardly.

11. An improved water filter apparatus as claimed in claim 1 wherein the filter cartridge has a filter end cap which is fixed over the distal end of the filter element remote from the supportive end body and having radiating lugs to help to centralise the filter element in the housing body.

12. A replaceable filter cartridge for an improved water filter apparatus of claim 1, and which comprises: a solid filter element securely fastened to a supportive end body to support the filter element within the housing body of a said water filter apparatus and having the form of a cap which is fastened over one end of the filter element and which, in use, channels fluid through the filter element to or from a said aperture of a said housing end cap of a said water filter apparatus.
